(19) United States
(12) Patent Application Publication
(10) Pub. No.: US 2020/0041830 A1
(43) Pub. Date: Feb. 6, 2020

(54) RETARDATION SUBSTRATE AND LIQUID CRYSTAL DISPLAY DEVICE

(71) Applicant: SHARP KABUSHIKI KAISHA, Sakai City, Osaka (JP)

(72) Inventors: KOJI MURATA, Sakai City, Osaka (JP); AKIRA SAKAI, Sakai City, Osaka (JP); YUICHI KAWAHIRA, Sakai City, Osaka (JP); MASAHIRO HASEGAWA, Sakai City, Osaka (JP); TAKAKO KOIDE, Sakai City, Osaka (JP); KOZO NAKAMURA, Sakai City, Osaka (JP); KIYOSHI MINOURA, Sakai City, Osaka (JP)

(21) Appl. No.: 16/499,145

(22) PCT Filed: Mar. 22, 2018
(86) PCT No.: PCT/JP2018/011360

§ 371 Date: Sep. 27, 2019

(30) Foreign Application Priority Data
Mar. 28, 2017 (JP) 2017-063068

(51) Int. Cl. G02F 1/13363; G02F 1/1335

(52) U.S. Cl. CPC G02F 1/13363; G02F 2001/133631; G02F 1/133528

(57) ABSTRACT

The present invention provides a retardation substrate capable of producing a liquid crystal display device more easily and a liquid crystal display device provided with the retardation substrate.

The retardation substrate of the present invention is a retardation substrate including a base material and an optical functional layer provided on one surface of the base material, in which the optical functional layer includes a retardation layer, and a direction of a slow axis of a surface of the optical functional layer is different from a direction of a slow axis inside the retardation layer.

### TECHNICAL FIELD

The present invention relates to a retardation substrate and a liquid crystal display device. More specifically, the present invention relates to a retardation substrate subjected to liquid crystal alignment treatment, and a liquid crystal display device including the retardation substrate.

### BACKGROUND ART

Liquid crystal display devices are display devices that use liquid crystal compositions for display, and the typical display mode thereof is irradiating a liquid crystal display panel containing a liquid crystal composition sealed between a pair of substrates with backlight and applying voltage to the liquid crystal composition to change the alignment of liquid crystal molecules, thereby controlling an amount of light passing through the liquid crystal display panel. Such liquid crystal display devices have features including a thin profile, lightweight, and low power consumption, and have therefore been used for electronic devices such as televisions, smartphones, tablet terminals, and car navigation systems. In such a liquid crystal display device, a retardation film (retardation layer) may be used for the purpose of color tone compensation, viewing angle compensation, and the like.

As a technique of fabricating a retardation layer, for example, Patent Literature 1 discloses a technique of producing a retardation film more simply and easily without forming an alignment film for aligning a liquid crystalline polymer of the retardation film. The technique of producing a retardation film includes the steps of: applying onto a substrate a composition containing a liquid crystalline polymer having a photoreactive group; distilling away a solvent in the composition to form a photoreactive layer; irradiating the photoreactive layer with linearly polarized light to form a thermally aligned layer; and heat-treating the thermally aligned layer at a temperature not less than a liquid crystal phase temperature of the liquid crystalline polymer and less than an isotropic phase transition temperature.

### CITATION LIST

### Patent Literature

Patent Literature 1: JP 2015-172756 A

### SUMMARY OF INVENTION

### Technical Problem

When a conventional liquid crystal display device is used outdoors, external light reflection becomes large inside and on the surface of the liquid crystal display device, so that visibility may be reduced (contrast may be lowered and discoloration may occur). In order to improve outdoor visibility, development of a γ-butyrolactone liquid crystal display device in which a retardation layer (also referred to as an in-cell retardation layer) is provided inside a liquid crystal cell is in progress.

FIG. 8 is a schematic cross-sectional view of a low reflection liquid crystal display device of Comparative Embodiment 1. As shown in FIG. 8, a low reflection liquid crystal display device 100 of Comparative Embodiment 1 has a first polarizer 110, an outcell retardation layer 120, a first substrate 130, an incell retardation layer 140, a liquid crystal layer 150, a second substrate 160, a second polarizer 170, and a backlight 180 in order from the viewing side to the backside. A first alignment film 151 for liquid crystal alignment is provided between the incell retardation layer 140 and the liquid crystal layer 150, and a second alignment film 152 for liquid crystal alignment is provided between the liquid crystal layer 150 and the second substrate 160.

The first substrate 130 includes a first transparent base material 131, a color filter/black matrix layer 132, and an overcoat layer 133 in order from the viewing side to the backside. The incell retardation layer 140 includes an alignment film 141 for retardation expression layer and a retardation expression layer 142 in order from the viewing side to the backside. The second substrate 160 includes a thin-film transistor layer 161 having a thin-film transistor, and a second transparent base material 162 in order from the viewing side to the backside. The first polarizer 110 and the second polarizer 170 are disposed such that the deflection axes are orthogonal to each other.

FIG. 9 is a flowchart showing a process of producing the incell retardation layer of Comparative Embodiment 1. As shown in FIG. 9, the incell retardation layer 140 in the low reflection liquid crystal display device 100 of Comparative Embodiment 1 is usually fabricated by two steps in which the alignment film 141 for retardation expression layer is formed and then the retardation expression layer 142 is formed on the alignment film 141 for retardation expression layer, so that the production process is complicated.

When the incell retardation layer 140 in the low reflection liquid crystal display device 100 of Comparative Embodiment 1 is fabricated using the method of Patent Literature 1, there is no need to form the alignment film 141 for retardation expression layer, and the incell retardation layer 140 can be fabricated by one step, so that the production process can be simplified.

However, when the incell retardation layer 140 is disposed between the first substrate 130 and the liquid crystal layer 150 as in the low reflection liquid crystal display device 100 of Comparative Embodiment 1, it is necessary to form the first alignment film 151 for liquid crystal alignment on the incell retardation layer 140. Here, when the alignment film for liquid crystal alignment is applied, a mixed solvent containing γ-butyrolactone, N-methylpyrrolidone (NMP), butyl cellosolve (BCS) and the like is used for the purpose of viscosity adjustment and wettability improvement. In the configuration of the low reflection liquid crystal display device 100 of Comparative Embodiment 1, when the first alignment film 151 for liquid crystal alignment is applied onto the incell retardation layer 140, the mixed solvent may dissolve the incell retardation layer 140. Thus, it is difficult to form the first alignment film 151 for liquid crystal alignment, and the production steps are complicated. Therefore, there has been a demand for a method of more easily producing a liquid crystal display device having an incell retardation layer.

The present invention has been made in view of such a current state of the art and aims to provide a retardation substrate capable of producing a liquid crystal display device more easily and a liquid crystal display device provided with the retardation substrate.

### Solution to Problem

The inventors of the present invention have made more detailed studies concerning a retardation substrate capable of producing a liquid crystal display device more easily and a liquid crystal display device provided with the retardation substrate. As a result, the inventors of the present invention have found that in a retardation substrate having an optical functional layer including a retardation layer, a direction of a slow axis of a surface of the optical functional layer is made different from a direction of a slow axis inside the retardation layer, so that a desired retardation is imparted using the retardation substrate, and, at the same time, liquid crystal molecules of a liquid crystal layer can be aligned at a desired angle using the slow axis of the surface of the optical functional layer without forming an alignment film for liquid crystal alignment on the optical functional layer. Thereby, the inventors have arrived at the solution to the above problem, completing the present invention.

That is, one aspect of the present invention may be a retardation substrate including a base material and an optical functional layer provided on one surface of the base material. In this retardation substrate, the optical functional layer may include a retardation layer, and a direction of a slow axis of a surface of the optical functional layer may be different from a direction of a slow axis inside the retardation layer.

An angle formed by the direction of the slow axis of the surface of the optical functional layer and the direction of the slow axis inside the retardation layer may be more than 43° and 47° or less.

The surface of the optical functional layer may include the retardation layer.

The optical functional layer may further include an inorganic film, and the surface of the optical functional layer may include the inorganic film.

The optical functional layer may have a retardation of λ/4.

Another aspect of the present invention may be a liquid crystal display device including the above retardation substrate.

The liquid crystal display device may further include a substrate facing the retardation substrate, and a liquid crystal layer provided between the retardation substrate and the substrate facing the retardation substrate. The retardation substrate may be disposed such that the optical functional layer is in contact with the liquid crystal layer.

### Advantageous Effects of Invention

The present invention can provide a retardation substrate capable of producing a liquid crystal display device more easily and a liquid crystal display device provided with the retardation substrate.

### BRIEF DESCRIPTION OF DRAWINGS

FIG. 1 is a schematic cross-sectional view showing a retardation substrate of Embodiment 1.

FIG. 2 is a schematic view for explaining a relationship between various axes and directions of an optical functional layer in the retardation substrate of Embodiment 1.

FIG. 3 is a schematic cross-sectional view showing a retardation substrate of Embodiment 2.

FIG. 4 is a schematic cross-sectional view showing a liquid crystal display device of Embodiment 3.

FIG. 5 is a schematic cross-sectional view showing a liquid crystal display device of Embodiment 4.

FIG. 6 shows photomicrographs at the time of black display of liquid crystal display devices of Examples 1, 2, 4 and 8 to 10.

FIG. 7 is a graph in which a relationship of a dark room contrast to an angle in a rubbing direction in Examples 1 to 7 is plotted.

FIG. 8 is a schematic cross-sectional view of a low reflection liquid crystal display device of Comparative Embodiment 1.

FIG. 9 is a flowchart showing a process of producing an incell retardation layer of Comparative Embodiment 1.

### DESCRIPTION OF EMBODIMENTS

Hereinafter, the present invention is described in more detail based on embodiments with reference to the drawings. The embodiments, however, are not intended to limit the scope of the present invention. The configurations of the embodiments may appropriately be combined or modified within the spirit of the present invention.

In the present specification, a “retardation layer” means a retardation layer that imparts an in-plane retardation of 10 nm or more to light having a wavelength of at least 550 nm. Incidentally, the light having a wavelength of 550 nm is light having a wavelength at which human visual sensitivity is the highest. The in-plane retardation is defined by R=(ns−nf)×d. Here, ns represents a larger one of principal refractive indices nx and ny in an in-plane direction of the retardation layer, and nf represents a smaller one of the principal refractive indices nx and ny in the in-plane direction of the retardation layer. The principal refractive index refers to a value for light having a wavelength of 550 nm unless otherwise noted. An in-plane slow axis of the retardation layer refers to an axis in a direction corresponding to ns, and an in-plane fast axis refers to an axis in a direction corresponding to nf. d represents a thickness of the retardation layer. In the present specification, the “retardation” means an in-plane retardation with respect to light having a wavelength of 550 nm unless otherwise noted.

In the present specification, a retardation of λ/4 refers to an in-plane retardation of a quarter wavelength (strictly, 137.5 nm) for light having a wavelength of at least 550 nm, and may be an in-plane retardation of 100 nm or more and 176 nm or less.

In the present specification, a “viewing side” means a side closer to a screen (display surface) of a liquid crystal display device, and a “backside” means a side farther from the screen (display surface) of the liquid crystal display device.

In the present specification, “angle of axis” and “angle in direction” each mean an angle from a direction (reference=0°) of a polarization axis of a polarizer on the backside to the axis and direction, and the explanation is made assuming that counterclockwise measurement is positive and clockwise measurement is negative.

In the present specification, two axes (directions) being orthogonal to each other indicates that an angle (absolute value) formed by the two axes is within a range of 90±3°, the angle is preferably within a range of 90±1°, more preferably 90±0.5°, particularly preferably 90° (perfectly orthogonal).

### Embodiment 1

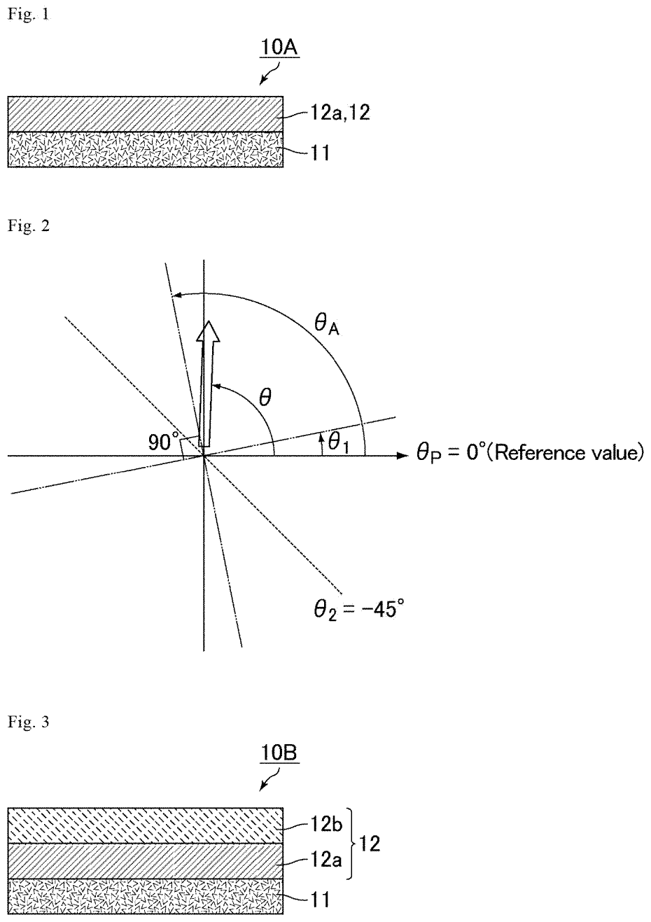

FIG. 1 is a schematic cross-sectional view showing a retardation substrate of Embodiment 1. As shown in FIG. 1, a retardation substrate 10A of Embodiment 1 has a base material 11 and an optical functional layer 12 provided on one surface of the base material 11, and the optical functional layer 12 is constituted of a retardation layer 12a. That is, a surface of the optical functional layer 12 is constituted of the retardation layer 12a. Another layer such as a color filter layer may be provided between the base material 11 and the retardation layer 12a.

The base material 11 is preferably a transparent base material having transparency, and examples thereof include glass base materials and plastic base materials.

The optical functional layer 12 has a function of changing the state of incident polarization by providing a retardation to two orthogonal polarization components using a birefringence material or the like, and also functions as an alignment film for forming a liquid crystal layer when the liquid crystal layer is provided on the optical functional layer 12. In the present embodiment, the optical functional layer 12 is the retardation layer 12a.

The optical functional layer 12 preferably has a retardation of λ/4. By setting the retardation of the optical functional layer 12 to λ/4, external light reflection can be further suppressed in a liquid crystal display device including the retardation substrate 10A as an incell retardation layer. The retardation of the optical functional layer 12 can be measured by using AxoScan (Mueller matrix polarimeter).

An angle formed by a direction of a slow axis of the surface of the optical functional layer 12 (direction of a slow axis of a surface of the retardation layer 12a) and a direction of a slow axis inside the retardation layer 12a is preferably more than 43° and 47° or less, more preferably 44° or more and 46.5° or less.

An angle θ₂ of the slow axis inside the retardation layer 12a is evaluated directly by using the retardation substrate 10A in which the retardation layer 12a is formed on the base material 11 with use of AxoScan (Mueller matrix polarimeter). When the angle θ₂ of the slow axis inside the retardation layer 12a is measured, a color filter layer or an overcoat layer may be formed on the retardation substrate 10A.

FIG. 2 is a schematic view for explaining a relationship between various axes and directions of the optical functional layer in the retardation substrate of Embodiment 1. A method of evaluating an angle θ₁ of the slow axis of the surface of the optical functional layer 12 will be described with reference to FIG. 2. An FFS mode liquid crystal standard cell is fabricated, in which a substrate including a common electrode (planar electrode) and a pixel electrode (comb electrode), an alignment film for liquid crystal alignment, a liquid crystal layer with positive liquid crystal molecules, the retardation substrate 10A, an outcell retardation layer having a retardation equal to that of the optical functional layer 12, and a first polarizer (analyzer) are stacked in order from the second polarizer side. At this time, the respective layers are disposed such that based on the direction of the polarization axis of the second polarizer (angle θ_{P} of the polarization axis of the polarizer θ_{P}=0°), an angle of a slow axis of the alignment film for liquid crystal alignment is 0°, the angle θ₂ of the slow axis inside the retardation layer 12a is −45° and an angle of a slow axis of the outcell retardation layer is 45°.

The liquid crystal standard cell thus fabricated is brought into a voltage non-application state where no voltage is applied between the common electrode and the pixel electrode, and then the analyzer is rotated with respect to the polarizer to take a microscope image at the time of black display in which black luminance is the smallest, and thus to determine an angle θ_{A} of a polarization axis of the analyzer at this time. An angle obtained by subtracting 90° from the angle θa of the polarization axis of the analyzer is the angle θ₁ (θ₁=θ_{A}−90°) of the slow axis of the surface of the retardation layer 12a.

The reason why the equation of θ₁=θ_{A}−90° holds can be explained as follows. An angle formed by the direction of the slow axis inside the retardation layer 12a and a direction of the slow axis of the outcell retardation layer is 90°, and the retardation of the retardation layer 12a and the retardation of the outcell retardation layer are equal to each other; therefore, a state in which both retardations are substantially absent is realized optically. Therefore, the black display is provided in the voltage non-application state when a direction of a polarization axis of the first polarizer forms an angle of 90° with a direction of a polarization axis of light passing through the liquid crystal layer, that is, when the direction of the polarization axis of the first polarizer forms an angle of 90° with the direction of the slow axis of the surface of the optical functional layer 12. Thus, θ_{A}=θ₁+90° holds, and the equation θ₁=θ_{A}−90° can be obtained.

As in the low reflection liquid crystal display device 100 of Comparative Embodiment 1, when the incell retardation layer 140 is disposed between the first substrate 130 and the liquid crystal layer 150, in a process of forming the first alignment film 151 for liquid crystal alignment on the incell retardation layer 140, a solvent may dissolve the incell retardation layer 140, and it is necessary to optimize a solvent species to be used, so that the production process is complicated.

However, in the retardation substrate 10A of the present embodiment, since the direction of the slow axis of the surface of the optical functional layer 12 is different from the direction of the slow axis inside the retardation layer 12a, a desired retardation is imparted using the retardation substrate 10A, and, at the same time, liquid crystal molecules of the liquid crystal layer can be aligned at a desired angle using the slow axis of the surface of the optical functional layer 12 without forming an alignment film for liquid crystal alignment on the optical functional layer 12. As a result, the liquid crystal display device can be produced more easily.

A film thickness of the retardation layer 12a is preferably 1.0 μm or more and 3.0 μm or less, more preferably 1.2 μm or more and 2.0 μm or less.

A material of the retardation layer 12a in the present embodiment is not limited, and, for example, the retardation layer 12a may be a layer formed using a liquid crystalline polymer having a photoreactive group (hereinafter also simply referred to as “liquid crystalline polymer”).

Examples of the liquid crystalline polymer include polymers having in their main chain a structure of acrylate, methacrylate, maleimide, N-phenyl maleimide, siloxane, or the like and having a side chain with a structure having both mesogenic groups such as biphenyl group, terphenyl group, naphthalene group, phenylbenzoate group, azobenzene group, and derivatives thereof, which are widely used as mesogenic components of liquid crystalline polymers, and photoreactive groups such as cinnamoyl group, chalcone group, cinnamylidene group, β-(2-phenyl) acryloyl group, cinnamic acid group, and derivatives thereof.

The liquid crystalline polymer may be a homopolymer consisting of a single repeating unit, or a copolymer consisting of two or more repeating units having different side chain structures. The copolymer includes any of an alternating type, a random type, a graft type and the like. In the copolymer, the side chain relating to at least one repeating unit is a side chain with a structure having both the mesogenic group and the photoreactive group. However, the side chain relating to the other repeating unit may not have the mesogenic group or the photoreactive group.

Preferred specific examples of the liquid crystalline polymer according to the present embodiment are shown below.

The liquid crystalline polymer is, for example, a copolymerizable (meth)acrylic acid polymer having a repeating unit represented by the following general formula (I).

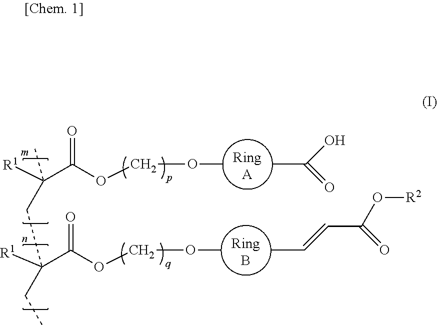

(In the above formula, R¹ is a hydrogen atom or a methyl group, R² is an alkyl group or a phenyl group substituted with a group selected from an alkyl group, an alkoxy group, a cyano group and a halogen atom, a ring A and a ring B are each independently a group represented by the following general formulas (M1) to (M5), p and q are each independently any integer of 1 to 12, and m and n are the mole fractions of each monomer in the copolymer satisfying a relationship of 0.65≤m≤0.95, 0.05≤n≤0.35, and m+n=1.)

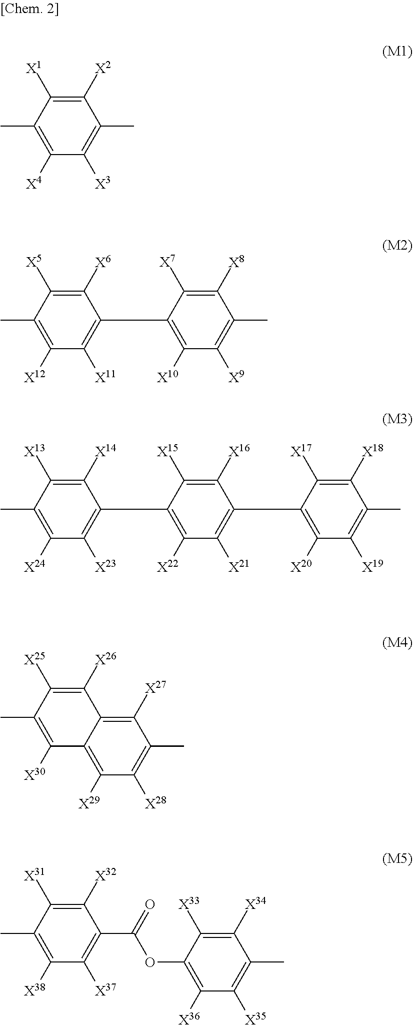

(In the above formula, X¹ to X³⁸ are each independently a hydrogen atom, an alkyl group, an alkoxy group, a halogen atom or a cyano group.)

The liquid crystalline polymer is preferably a copolymerizable (meth)acrylic acid polymer having a repeating unit represented by the following general formula (I-a).

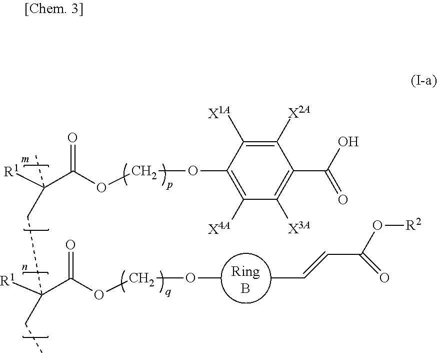

(In the above formula, R¹ is a hydrogen atom or a methyl group, R² is an alkyl group or a phenyl group substituted with a group selected from an alkyl group, an alkoxy group, a cyano group and a halogen atom, X^{1A} to X^{4A} are each independently a hydrogen atom, an alkyl group, an alkoxy group, a halogen atom or a cyano group, a ring B is a group represented by the following general formula (M1a) or (M5a), p and q are each independently any integer of 1 to 12, and m and n are the mole fractions of each monomer in the copolymer satisfying a relationship of 0.65≤m≤0.95, 0.05≤n≤0.35, and m+n=1.)

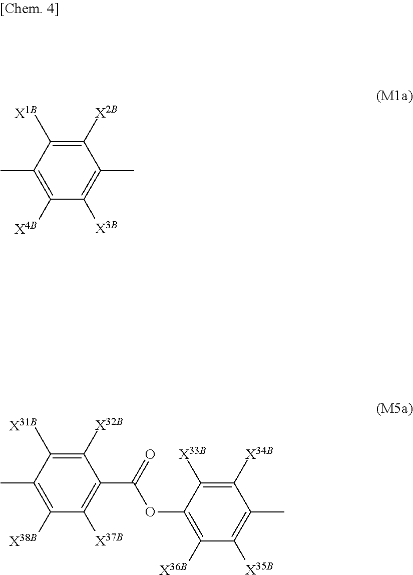

(In the above formula, X^{1B} to X^{4B} and X^{31B} to X^{38B} are each independently a hydrogen atom, an alkyl group, an alkoxy group, a halogen atom or a cyano group.)

Furthermore, the liquid crystalline polymer is preferably a copolymerizable (meth)acrylic acid polymer having a repeating unit represented by the following general formula (I-b) or (I-c).

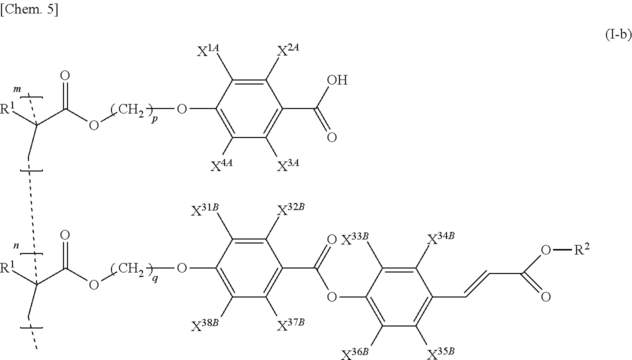

(In the above formula, R¹ is a hydrogen atom or a methyl group, R² is an alkyl group or a phenyl group substituted with a group selected from an alkyl group, an alkoxy group, a cyano group and a halogen atom, X^{1A} to X^{4A} and X^{31B} to X^{38B} are each independently a hydrogen atom, an alkyl group, an alkoxy group, a halogen atom or a cyano group, p and q are each independently any integer of 1 to 12, and m and n are the mole fractions of each monomer in the copolymer satisfying a relationship of 0.65≤m≤0.95, 0.05≤n≤0.35, and m+n=1.)

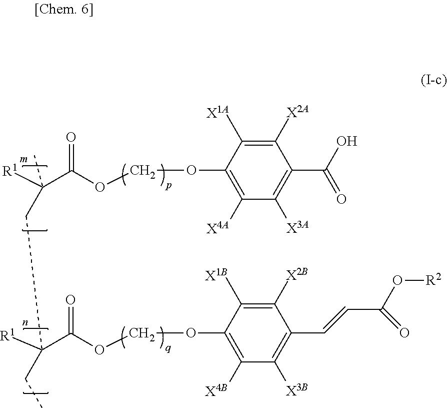

(In the above formula, R¹ is a hydrogen atom or a methyl group, R² is an alkyl group or a phenyl group substituted with a group selected from an alkyl group, an alkoxy group, a cyano group and a halogen atom, X^{1A} to X^{4A} and X^{1B} to X^{4B} are each independently a hydrogen atom, an alkyl group, an alkoxy group, a halogen atom or a cyano group, p and q are each independently any integer of 1 to 12, and m and n are the mole fractions of each monomer in the copolymer satisfying a relationship of 0.65≤m≤0.95, 0.05≤n≤0.35, and m+n=1.)

In the general formula (I) (including the general formula (I-a), the general formula (I-b), and the general formula (I-c); the same shall apply hereinafter) of the present embodiment, R¹ is preferably a methyl group. R² is preferably an alkyl group or a phenyl group substituted with one group selected from an alkyl group, an alkoxy group, a cyano group and a halogen atom. Among these groups, an alkyl group or a phenyl group substituted with an alkoxy group or a cyano group is more preferred, and an alkyl group or a phenyl group substituted with an alkoxy group is particularly preferred.

X^{31B} to X^{38B} are each preferably a hydrogen atom or a halogen atom, and it is most preferable that all X³¹ to X^{38B} are a hydrogen atom.

p and q are each preferably any integer of 3 to 9, any integer of 5 to 7 is preferred among them, and 6 is the most preferred. m is preferably within a range of 0.75≤m≤0.85 and most preferably 0.8. A preferred range of corresponding n is a range determined accordingly from m+n=1. That is, n is preferably within a range of 0.15≤n≤0.25 and most preferably 0.2.

In the general formula (I-a), (I-b) or (I-c) of the present embodiment, X^{1A} to X^{4A} are each preferably a hydrogen atom or a halogen atom, and in particular, a case is preferable where any one of X^{1A} to X^{4A} is a halogen atom and the others are hydrogen atoms, or all X^{1A} to X^{4A} are hydrogen atoms. In the general formula (I-b) of the present embodiment, X^{31B} to X^{38B} are each preferably a hydrogen atom or a halogen atom, and it is most preferable that all X^{31B} to X^{38B} are hydrogen atoms. In the general formula (I-c) of the present embodiment, X^{1B} to X^{4B} are each preferably a hydrogen atom or a halogen atom, and it is most preferable that all X^{1B} to X^{4B} are hydrogen atoms.

Examples of the alkyl group of R² or the alkyl group as the substituent of the phenyl group of R² include an alkyl group having 1 to 12 carbon atoms, and among these, an alkyl group having 1 to 6 carbon atoms is preferred, an alkyl group having 1 to 4 carbon atoms is more preferred, and a methyl group is the most preferred. Examples of the alkoxy group as the substituent of the phenyl group of R² include an alkoxy group having 1 to 12 carbon atoms, and among these, an alkoxy group having 1 to 6 carbon atoms is preferred, an alkoxy group having 1 to 4 carbon atoms is more preferred, and a methoxy group is the most preferred. Examples of the halogen atom as the substituent of the phenyl group of R² include a fluorine atom, a chlorine atom, a bromine atom, and an iodine atom, of which fluorine atom is preferred.

In X¹ to X³⁸, examples of the alkyl group include those having 1 to 4 carbon atoms, of which methyl group is the most preferred. Examples of the alkoxy group include those having 1 to 4 carbon atoms, of which methoxy group is the most preferred. Examples of the halogen atom include a fluorine atom, a chlorine atom, a bromine atom and an iodine atom, of which fluorine atom is preferable.

In the present specification, for X¹ to X³⁸ that are substituents on the ring A or ring B, X^{1A} to X^{38A} indicate the case where they are substituents on the ring A, and X^{1B} to X³⁸⁸ indicate the case where they are substituents on the ring B. Therefore, the description of X¹ to X³⁸ is also applicable to X^{1A} to X^{38A} and X^{1B} to X^{38B} as it is.

Next, a method of producing the retardation substrate 10A according to the present embodiment will be described.

The liquid crystalline polymer according to the present embodiment can be dissolved in a solvent to form a composition for retardation layer. In addition to a photopolymerization initiator, a surfactant, and the like, a component usually contained in a polymerizable composition which causes polymerization by light and heat may be appropriately added to the composition for retardation layer.

A content of the liquid crystalline polymer according to the present embodiment with respect to the composition for retardation layer is preferably 10% by weight or more and 40% by weight or less, more preferably 15% by weight or more and 35% by weight or less, still more preferably 20% by weight or more and 30% by weight or less.

A content of the solvent in the composition for retardation layer is not particularly limited as long as the liquid crystalline polymer dissolves, but the content of the solvent is usually, for example, 70% by weight or more and 99% by weight or less based on the total weight of the liquid crystalline polymer. A content of the other optional component is not particularly limited, but it is preferable that a content of the photopolymerization initiator is usually, for example, 1% by weight or more and 10% by weight or less, and a content of the surfactant is usually, for example, 0.1% by weight or more and 5% by weight or less, based on the total weight of the liquid crystalline polymer.

Examples of the solvent used for the composition for retardation layer include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methyl cyclohexane, tetrahydrofuran, dioxane, cyclohexanone, n-hexane, ethyl acetate, butyl acetate, propylene glycol methyl ether acetate, methoxybutyl acetate, N-methylpyrrolidone, and dimethylacetamide. Among these solvents, methyl ethyl ketone and cyclohexanone are preferred from the viewpoint of toxicity and environmental load and/or from the viewpoint of solubility resistance to resin base materials (such as polyethylene terephthalate (PET) and cycloolefin polymer (COP)). One of these solvents may be used alone, or two or more thereof may be used in combination. In particular, a polymer (I) of the present embodiment has an excellent feature of being soluble in methyl ethyl ketone and cyclohexanone.

As the photopolymerization initiator, it is possible to use any of general-purpose photopolymerization agents generally known in order to form a uniform film by irradiation with a small amount of light. Specific examples thereof include azonitrile-based photopolymerization initiators such as 2,2′-azobisisobutyronitrile and 2,2′-azobis (2,4-dimethylvaleronitrile), α-aminoketone-based photopolymerization initiators such as Irgacure 907 (Ciba Specialty Chemicals) and Irgacure 369 (Ciba Specialty Chemicals), acetophenone-based photopolymerization initiators such as 4-phenoxydichloroacetophenone, 4-t-butyl-dichloroacetophenone, diethoxyacetophenone, 1-(4-isopropylphenyl)-2-hydroxy-2-methylpropan-1-one, 1-hydroxycyclohexyl phenyl ketone, and 2-benzyl-2-dimethylamino-1-(4-morpholinophenyl)-butan-1-one, benzoin-based photopolymerization initiators such as benzoin, benzoin methyl ether, benzoin ethyl ether, benzoin isopropyl ether, and benzyl dimethyl ketal, benzophenone-based photopolymerization initiators such as benzophenone, benzoylbenzoic acid, methyl benzoylbenzoate, 4-phenylbenzophenone, hydroxybenzophenone, acrylated benzophenone, and 4-benzoyl-4′-methyl diphenyl sulfide, thioxanthone-based photopolymerization initiators such as 2-chlorothioxanthone, 2-methylthioxanthone, isopropylthioxanthone, and 2,4-diisopropylthioxanthone, triazine-based photopolymerization initiators such as 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, 2-(naphtho-1-yl)-4,6-bis(trichloromethyl)-s-triazine, 2-(4-methoxy-naphtho-1-yl)-4,6-bis (trichloromethyl)-s-triazine, 2,4-trichloromethyl-(piperonyl)-6-triazine, and 2,4-trichloromethyl(4′-methoxystyryl)-6-triazine, carbazole-based photopolymerization initiators, and imidazole-based photopolymerization initiators. Furthermore examples of the photopolymerization initiator include α-acyloxy esters, acyl phosphine oxides, methylphenylglyoxylate, benzyl, 9,10-phenanthrenequinone, camphorquinone, ethyl anthraquinone, 4,4′-diethylisophthalophenone, 3,3′,4,4′-tetra(t-butylperoxycarbonyl)benzophenone, 4,4′-diethylaminobenzophenone, and thioxanthone. These photopolymerization initiators may be used singly or in combination of two or more of them.

As the surfactant, it is possible to use any of surfactants generally used in order to form a uniform film. Specific examples thereof include anionic surfactants such as sodium lauryl sulfate, ammonium lauryl sulfate, triethanolamine lauryl sulfate, polyoxyethylene alkyl ether sulfate, alkyl ether phosphate, sodium oleyl succinate, potassium myristate, coconut oil fatty acid potassium, and sodium lauroyl sarcosinate; nonionic surfactants such as polyethylene glycol monolaurate, sorbitan stearate, glyceryl myristate, glyceryl dioleate, sorbitan stearate, and sorbitan oleate; cationic surfactants such as stearyl trimethyl ammonium chloride, behenyl trimethyl ammonium chloride, stearyl dimethyl benzyl ammonium chloride, and cetyl trimethyl ammonium chloride; and ampholytic surfactants such as alkyl betaine including lauryl betaine, alkyl sulfobetaine, cocamidopropyl betaine, and alkyl dimethylaminoacetic acid betaine, alkyl imidazoline, sodium lauroyl sarcosine, and sodium cocoamphoacetate. Furthermore examples of the surfactants include BYK-361, BYK-306, BYK-307 (manufactured by BYK Chemie Japan), Florard FC430 (manufactured by Sumitomo 3M Limited), Megafac F171, and R08 (manufactured by DIC Corporation). One of these surfactants may be used alone, or two or more thereof may be used in combination.

The retardation substrate 10A according to the present embodiment can be fabricated by applying the composition for retardation layer described above on the base material 11. As a method of applying the composition for retardation layer, any method generally known in the relevant field may be used. For example, the method includes a spin coating method, a bar coating method, a die coater method, a screen printing method, and a spray coater method.

Next, the composition for retardation layer applied on the base material 11 is dried under reduced pressure or naturally dried and then dried by heating to distill away the solvent contained in the composition for retardation layer. It is preferable that the composition for retardation layer applied on the base material 11 is naturally dried and then dried by heating. Here, “to distill away the solvent” means to remove the solvent to such an extent that a remaining solvent cannot be detected, and for example, the level is equal to or less than the detection limit in measurement by gas chromatography. The layer thus formed on the base material 11 and containing the liquid crystalline polymer is referred to as a photoreactive layer.

The photoreactive layer is irradiated with linearly polarized light, and the photoreactive group in the side chain of the liquid crystalline polymer is selectively reacted (dimerization, isomerization, etc.) with the polarization axis of the linearly polarized light to impart liquid crystal alignment ability to the photoreactive layer. Although the linearly polarized light can be applied from any of the vertical direction and the oblique direction with respect to the photoreactive layer, it is usually preferable to apply the linearly polarized light from the vertical direction.

In the present embodiment, the linearly polarized light is light in which as for a face including a vibration direction of an electric field (or magnetic field), a specific surface is specified. The linearly polarized light can be obtained by using a polarizing filter or a polarizing prism for light from a light source. The light to be applied is not particularly limited as long as the light is radiation capable of causing dimerization, isomerization and the like by the action on the photoreactive group through irradiation, and includes, for example, infrared light, visible light, ultraviolet light (e.g., near ultraviolet light and far ultraviolet light), X-ray, and charged particle beam (e.g., electron charge). Usually, the radiation often has a wavelength of 200 nm or more and 500 nm or less, and in particular, near ultraviolet light of 350 nm to 450 nm is preferred.

Examples of the light source include a xenon lamp, a high-pressure mercury lamp, an extra-high-pressure mercury lamp, and a metal halide lamp. By using an interference filter, a color filter, or the like with respect to ultraviolet rays or visible rays obtained from the light source, the wavelength range of the irradiation may be restricted.

The irradiation energy varies depending on the type of the liquid crystalline polymer, the coating amount and the like, but is usually 5 mJ/cm² or more and 50 mJ/cm² or less. When a photomask is used in the application of polarized light, the liquid crystal alignment ability can be provided in a pattern shape in two or more different directions. Specifically, after the composition for retardation film of the present embodiment is applied and dried, a photomask is covered thereon and irradiated with linearly polarized light, and thus to impart the liquid crystal alignment ability to only an exposed portion. By repeating this process while changing directions, as necessary, the liquid crystal alignment ability can be provided in a pattern shape in multiple directions. The layer thus formed is referred to as a thermally aligned layer.

The thermally aligned layer is heat-treated to align a side chain portion of the liquid crystalline polymer, which has not caused a photoreaction, in a certain direction, and a retardation layer before rubbing treatment can be obtained. The conditions for the heat treatment may be any conditions sufficient for allowing the alignment to proceed, and heating may be performed at a heating temperature equal to or more than a liquid crystal phase temperature of the liquid crystalline polymer. However, the heating temperature is preferably less than an isotropic phase transition temperature of the liquid crystalline polymer. The specific heating temperature is generally preferably 80° C. or more and 250° C. or less, more preferably 100° C. or more and 200° C. or less, still more preferably 120° C. or more and 170° C. or less. The heating time is preferably 5 minutes or more and 60 minutes or less, more preferably 10 minutes or more and 50 minutes or less, still more preferably 10 minutes or more and 40 minutes or less.

Next, the rubbing treatment is applied to a surface of the retardation layer before rubbing treatment at an angle θ in the rubbing direction so that the angle θ₁ of the slow axis of the surface of the retardation layer 12a after rubbing treatment is different from the angle θ₂ of the slow axis inside the retardation layer 12a after rubbing treatment, whereby the retardation substrate 10A according to the present embodiment can be fabricated.

The rubbing treatment of the surface of the retardation layer before rubbing treatment can be carried out by pressing a rubbing roller against the retardation layer before rubbing treatment while rotating the rubbing roller.

In the rubbing treatment of the retardation layer before rubbing treatment, the angle θ in the rubbing direction preferably satisfies 70°≤θ≤110°, more preferably 75°≤θ≤105°, still more preferably 77°≤θ≤103°. This makes it possible to improve a dark room contrast of a liquid crystal display device including the retardation substrate 10A according to the present embodiment.

Examples of the rubbing roller used when the retardation layer before rubbing treatment is subjected to the rubbing treatment include a roller wound with a rubbing cloth having a pile woven on its surface and a roller with irregularities on its surface, and a roller wound with a rayon rubbing cloth is preferably used.

When the roller wound with the rubbing cloth is used, a roller pressing amount, which is an amount (length) by which the tip of the pile is pressed into the retardation layer before rubbing treatment, is preferably 0.1 mm or more and 0.5 mm or less, more preferably 0.30 mm or more and 0.45 mm or less.

In the rubbing treatment of the retardation layer before rubbing treatment, the number of rotations of the rubbing roller is preferably 200 rpm or more and 800 rpm or less, more preferably 300 rpm or more and 700 rpm or less.

In the rubbing treatment of the retardation layer before rubbing treatment, it is preferable to press the rubbing roller against an alignment film before rubbing treatment while moving the alignment film before rubbing treatment with respect to the rubbing roller. A moving speed of the alignment film before rubbing treatment is preferably 5 mm/s or more and 30 mm/s or less, more preferably 10 mm/s or more and 20 mm/s or less.

The rubbing treatment of the retardation layer before rubbing treatment may be repeatedly applied to the entire surface of the retardation layer before rubbing treatment, but it is preferable to apply the rubbing treatment once (that is, the number of repetitions is 1) to the entire surface of the retardation layer before rubbing treatment.

### Embodiment 2

A retardation substrate of Embodiment 2 has the same configuration as that of the retardation substrate 10A of Embodiment 1, except that an inorganic film is further provided on the retardation layer before rubbing treatment of Embodiment 1 and the rubbing treatment is applied to the inorganic film. Thus, in the present embodiment, features peculiar to this embodiment will be mainly described, and description overlapping with Embodiment 1 will be omitted as appropriate.

FIG. 3 is a schematic cross-sectional view showing a retardation substrate of Embodiment 2. As shown in FIG. 3, a retardation substrate 10B of Embodiment 2 has a base material 11 and an optical functional layer 12 provided on one surface of the base material 11. The optical functional layer 12 is constituted of a retardation layer 12a and an inorganic film 12b, and the retardation layer 12a and the inorganic film 12b are stacked in this order from the base material 11 side. That is, a surface of the optical functional layer 12 is constituted of the inorganic film 12b. Another layer such as a color filter layer may be provided between the base material 11 and the retardation layer 12a.

Similarly to the retardation substrate 10A of Embodiment 1, in the retardation substrate 10B of Embodiment 2, an angle θ₁ of a slow axis of a surface of the optical functional layer 12 (that is, a surface of the inorganic film 12b) is made different from an angle θ₂ of a slow axis inside the retardation layer 12a, so that a desired retardation is imparted using the retardation substrate 10B, and, at the same time, liquid crystal molecules of a liquid crystal layer can be aligned at a desired angle using the slow axis of the surface of the optical functional layer 12 without forming an alignment film for liquid crystal alignment on the optical functional layer 12.

When the surface of the optical functional layer 12 is constituted of the inorganic film 12b, in the case where a liquid crystal layer is provided on the retardation substrate 10B to produce a liquid crystal display device, it is possible to suppress permeation of impurities into the liquid crystal layer from the retardation layer 12a or a color filter layer. As a result, the liquid crystal display device can achieve a high voltage holding ratio (VHR).

The inorganic film 12b can be easily formed by a dry process, and as the inorganic film 12b, materials such as silicon oxide (SiO₂) and silicon nitride (SiN_{X} (where X is a positive number), preferably SiN) can be used, for example.

A relative permittivity e of the inorganic film 12b is preferably 1.0<ε<9.0, more preferably 3.0<ε<7.5. The relative permittivity of air is 1.00059, the relative permittivity of SiO₂ is 3.5, the relative permittivity of SiN is 7.0, and the relative permittivity of ITO is 9.0.

The inorganic film 12b can be formed by using a sputtering method, a vapor deposition method, a plasma chemical vapor deposition (CVD) method, or the like.

A thickness of the inorganic film 12b is preferably 50 nm or more and 1000 nm or less, more preferably 80 nm or more and 500 nm or less, still more preferably 100 nm or more and 300 nm or less.

In the present embodiment, the rubbing treatment is applied to a surface of the inorganic film 12b, whereby a direction of the slow axis of the surface of the optical functional layer 12, that is, a direction of the slow axis of the surface of the inorganic film 12b can be made different from a direction of the slow axis inside the retardation layer 12a.

The rubbing treatment of the surface of the inorganic film 12b can be carried out by pressing a rubbing roller against the inorganic film 12b while rotating the rubbing roller.

In the rubbing treatment of the inorganic film 12b, an angle θ in the rubbing direction preferably satisfies −20°≤θ≤20°, more preferably −15°≤θ≤15°. This makes it possible to improve a dark room contrast of a liquid crystal display device including the retardation substrate 10B according to the present embodiment. Here, the preferred range of the angle θ in the rubbing direction in the present embodiment is different from the preferred range of Embodiment 1. In Embodiment 1, it is preferable to consider the influence of the slow axis inside the retardation layer 12a on the slow axis of the surface of the retardation layer 12a because the rubbing treatment is applied to the retardation layer 12a. On the other hand, in the present embodiment, since the rubbing treatment is applied to the inorganic film 12b, such an influence may not be taken into consideration. As a result, the preferred range of the angle θ in the rubbing direction in the present embodiment is different from that of Embodiment 1.

Examples of the rubbing roller used when the inorganic film 12b is subjected to the rubbing treatment include a roller wound with a rubbing cloth having a pile woven on its surface and a roller with irregularities on its surface, and a roller wound with a rayon rubbing cloth is preferably used.

When the roller wound with the rubbing cloth is used, a roller pressing amount, which is an amount (length) by which the tip of the pile is pressed into the inorganic film 12b, is preferably 0.1 mm or more and 0.5 mm or less, more preferably 0.30 mm or more and 0.45 mm or less.

In the rubbing treatment of the inorganic film 12b, the number of rotations of the rubbing roller is preferably 200 rpm or more and 800 rpm or less, more preferably 300 rpm or more and 700 rpm or less.

In the rubbing treatment of the inorganic film 12b, it is preferable to press the rubbing roller against an inorganic film 12b while moving the inorganic film 12b with respect to the rubbing roller, and a moving speed of the inorganic film 12b is preferably 5 mm/s or more and 30 mm/s or less, more preferably 10 mm/s or more and 20 mm/s or less.

The rubbing treatment of the inorganic film 12b may be repeatedly applied to the entire surface of the inorganic film 12b, but it is preferable to apply the rubbing treatment once (that is, the number of repetitions is 1) to the entire surface of the inorganic film 12b.

### Embodiment 3

A liquid crystal display device of Embodiment 3 is a liquid crystal display device in which various members such as color filters and electrodes are disposed on the retardation substrate 10A of Embodiment 1. Thus, in the present embodiment, features peculiar to this embodiment will be mainly described, and description overlapping with Embodiment 1 will be omitted as appropriate.

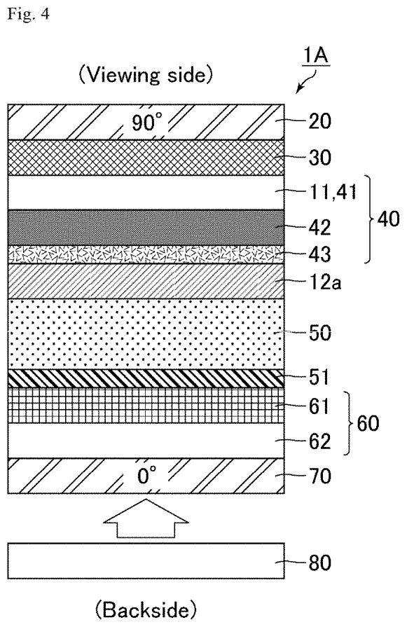

FIG. 4 is a schematic cross-sectional view showing a liquid crystal display device of Embodiment 3. As shown in FIG. 4, a liquid crystal display device 1A has a first polarizer 20, an outcell retardation layer 30, a first substrate 40, a retardation layer 12a, a liquid crystal layer 50, a second substrate (facing substrate) 60, a second polarizer 70, and a backlight 80 in order from the viewing side to the backside. The retardation layer 12a is used as an incell retardation layer.

The first substrate 40 includes a first transparent base material 41, a color filter/black matrix layer 42, and an overcoat layer 43 in order from the viewing side to the backside. The first transparent base material 41 functions as a base material 11 of the retardation substrate 10A.

The second substrate 60 includes a thin-film transistor layer 61 and a second transparent base material 62 in order from the viewing side to the backside. An alignment film 51 for liquid crystal alignment is provided between the liquid crystal layer 50 and the second substrate 60.

In the liquid crystal display device 1A of Embodiment 3, the liquid crystal layer 50 can be formed directly on the retardation substrate 10A, and there is no need to further form an alignment film for liquid crystal alignment on the first substrate 40 side, so that the liquid crystal display device can be produced more easily.

As the first polarizer 20 and the second polarizer 70, polarizers obtained by dyeing and adsorbing an anisotropic material such as iodine complex (or dye) on a polyvinyl alcohol (PVA) film and then drawing and aligning the film can be used, for example.

The outcell retardation layer 30 is a layer that changes the state of incident polarization by providing a retardation to two orthogonal polarization components using a birefringence material or the like. As the outcell retardation layer 30, a liquid crystalline polymer as used in the retardation layer 12a may be used, and a stretched polymer film generally used in the field of liquid crystal display devices may be used. Examples of the material of the polymer film include cycloolefin polymers, polycarbonates, polysulfones, polyether sulfones, polyethylene terephthalates, polyethylenes, polyvinyl alcohols, norbornenes, triacetylcelluloses, and diacetylcelluloses, among which cycloolefin polymers are preferred. A retardation layer formed of a cycloolefin polymer is excellent in durability, and has an advantage that a change in retardation is small when the retardation layer is exposed to a high temperature environment or a high temperature and high humidity environment for a long time of period. As a film of a cycloolefin polymer, “ZEONOR Film (registered trademark)” manufactured by Zeon Corporation, “ARTON (registered trademark) Film” manufactured by JSR Corporation, and the like are known.

The color filter/black matrix layer 42 has a configuration in which a red color filter, a green color filter and a blue color filter are arranged in a plane and partitioned by a black matrix. The red color filter, the green color filter, the blue color filter, and the black matrix are formed of, for example, a transparent resin containing a pigment. Usually, a combination of the red color filter, the green color filter and the blue color filter is disposed in all pixels, and a desired color is obtained at each pixel by mixing colors while controlling the amount of color light transmitted through the red color filter, the green color filter and the blue color filter. For example, a black photosensitive acrylic resin or the like can be used as the black matrix.

The overcoat layer 43 covers a surface of the color filter/black matrix layer 42 on the liquid crystal layer 50 side. By providing the overcoat layer 43, elution of impurities in the color filter/black matrix layer 42 into the liquid crystal layer 50 can be prevented. As a material of the overcoat layer 43, a transparent resin is suitable.

The liquid crystal layer 50 contains a liquid crystal composition. The liquid crystal layer 50 controls a quantity of transmitting light by applying voltage to the liquid crystal layer 50 and changing an alignment state of liquid crystal molecules in the liquid crystal composition according to the applied voltage.

The liquid crystal molecules used in the present embodiment are rod-like liquid crystal molecules, and the liquid crystal molecules may have positive or negative value for the anisotropy of dielectric constant (Δε) defined by the formula below. Liquid crystal molecules having positive anisotropy of dielectric constant are also referred to as positive liquid crystals, and liquid crystal molecules having negative anisotropy of dielectric constant are also referred to as negative liquid crystals. The major axis direction of the liquid crystal molecules is the direction of the slow axis. Liquid crystal molecules are homogeneously aligned in a state in which no voltage is applied (voltage non-application state), and a direction of a major axis of the liquid crystal molecules in the voltage non-application state is also referred to as a direction of initial alignment of the liquid crystal molecules.

Δε=(dielectric constant in the major axis direction)−(dielectric constant in the minor axis direction)

The liquid crystal molecules having positive anisotropy of dielectric constant are preferably used because the liquid crystal molecules can further improve the response speed. In addition, the liquid crystal molecules having negative anisotropy of dielectric constant are preferably used because the alignment state of the liquid crystal molecules is less likely to disturb even when disturbance occurs in the electric field being applied and light scattering is less likely to occur (transmittance is improved) as compared with liquid crystal molecules having positive anisotropy of dielectric constant.

The alignment film 51 for liquid crystal alignment has a function of controlling alignment of liquid crystal molecules in the liquid crystal layer 50. When a voltage applied to the liquid crystal layer 50 is less than a threshold voltage (including no voltage application), the alignment of the liquid crystal molecules in the liquid crystal layer 50 is controlled mainly by the action of the retardation substrate 10A and the alignment film 51 for liquid crystal alignment. The alignment film 51 for liquid crystal alignment is a layer subjected to alignment treatment for controlling alignment of liquid crystal molecules, and as the alignment film 51 for liquid crystal alignment, an alignment film generally used in the field of liquid crystal display panels such as polyimide can be used.

A film thickness of the alignment film 51 for liquid crystal alignment is preferably 50 nm or more and 200 nm or less, more preferably 80 nm or more and 120 nm or less.

The second substrate 60 is a thin-film transistor array substrate, and the second substrate 60 includes the thin-film transistor layer 61 having a thin-film transistor (TFT) and the second transparent base material 62 in order from the viewing side to the backside.

The thin-film transistor layer 61 is a layer including at least a TFT, which is a switching element used to switch on/off of a pixel of the liquid crystal display device, and includes wirings and electrodes connected to the TFT, insulating films to electrically separate the wirings and the electrodes, and the like.

A liquid crystal drive mode of the liquid crystal display device of the embodiment is not particularly limited. Examples thereof include Fringe Field Switching (FFS) mode, In-Plane Switching (IPS) mode, Optically Compensated Birefringence (OCB) mode, TN mode, Multi-domain Vertical Alignment (MVA) mode, and Vertical Alignment (VA) mode, and a horizontal alignment mode such as FFS mode or IPS mode is preferably used.

In the horizontal alignment mode, a pair of electrodes that generate a transverse electric field in the liquid crystal layer 50 by applying voltage is used. In the FFS mode, the second substrate 60 includes a common electrode (planar electrode), an insulating film covering the common electrode, and a pixel electrode (comb electrode) disposed on the surface of the insulating film on the liquid crystal layer 50 side. According to such a configuration, a transverse electric field (fringe electric field) can be generated in the liquid crystal layer 50 by applying voltage between the common electrode and the pixel electrode constituting the pair of electrodes. Thus, the alignment of the liquid crystal molecules in the liquid crystal layer 50 can be controlled by adjusting the voltage applied between the common electrode and the pixel electrode.

Examples of the material of the common electrode and the pixel electrode include indium tin oxide (ITO) and indium zinc oxide (IZO). Examples of the material of the insulating film include an organic insulating film and a nitride film.

In the IPS mode, a transverse electric field is generated in the liquid crystal layer 50 by applying voltage to a pair of comb electrodes, and the alignment of the liquid crystal molecules in the liquid crystal layer 50 can be controlled.

The first transparent base material 41 and the second transparent base material 62 are each preferably a transparent base material having transparency, and examples thereof include glass base materials and plastic base materials.

The backlight 80 may be of any type such as an edge-lit backlight or a direct-lit backlight. A light source of the backlight 80 may be of any type such as light emitting diodes (LEDs) or cold cathode fluorescent lamps (CCFLs).

An angle formed by a polarization axis of the first polarizer 20 and a polarization axis of the second polarizer 70 is preferably 88° or more and 92° or less, more preferably 89° or more and 91° or less, still more preferably 89.7° or more and 90.3° or less. According to such a configuration, a good black display state can be realized in the voltage non-application state.

The outcell retardation layer 30 is preferably a retardation layer (λ/4 plate) that imparts an in-plane retardation of ¼ wavelength to light having a wavelength of at least 550 nm, and specifically preferably a retardation layer that imparts an in-plane retardation of 100 nm or more and 176 nm or less to the light having a wavelength of at least 550 nm. When the outcell retardation layer 30 functions as a λ/4 plate, this can function a combination of the first polarizer 20 and the outcell retardation layer 30 as a circular polarizing plate. Thereby, internal reflection of the liquid crystal display device can be reduced, so that a good black display in which the reflection (projection) of external light is suppressed can be realized.

In a liquid crystal display device in a circularly polarized FFS mode in which only the outcell retardation layer 30 is incorporated into an FFS mode liquid crystal display device, black display cannot be performed. Therefore, by further providing the retardation layer 12a as an incell retardation layer, the performance of the liquid crystal display device in a circularly polarized FFS mode can be improved. It is preferable that a slow axis of the outcell retardation layer 30 and the slow axis inside the retardation layer 12a are orthogonal to each other and a retardation value of the outcell retardation layer 30 and a retardation value of the retardation layer 12a are equal to each other. Thereby, the outcell retardation layer 30 and the retardation layer 12a can cancel the retardation each other with respect to light incident from the normal direction of the liquid crystal display device, and a state in which both of them substantially do not exist optically is realized. That is, a configuration is realized that is optically equivalent to a conventional liquid crystal display panel in a transverse electric field mode with respect to light entering the liquid crystal display device from the backlight 80. Thus, display in a transverse electric field mode using a circular polarizing plate can be realized.

From the viewpoint of exhibiting the function of the retardation layer, an angle formed by the slow axis of the outcell retardation layer 30 and the slow axis inside the retardation layer 12a is preferably within a range of 45±2°, more preferably within a range of 45±1°, still more preferably within a range of 45±0.3°, particularly preferably 45°, with respect to the polarization axis of the second polarizer 70. That is, it is preferable that one of an angle of the slow axis of the outcell retardation layer 30 and an angle θ₂ of the slow axis inside the retardation layer 12a is within a range of 45±2° and the other angle is within a range of −45±2°, it is more preferable that one of the angle and the angle θ₂ is within a range of 45±1° and the other angle is within a range of −45±1°, it is still more preferable that one of the angle and the angle θ₂ is within a range of 45±0.3° and the other angle is within a range of −45±0.3°, and it is particularly preferable that one of the angle and the angle θ₂ is 45° and the other angle is −45°.

In a preferred disposition of the optical axes in the present embodiment, for example, when an angle θ_{P} of the polarization axis of the second polarizer 70 is 0°, the angle θ₂ of the slow axis inside the retardation layer 12a is within a range of −45±2°, an angle of a direction of initial alignment of the liquid crystal molecules in the liquid crystal layer 50 is within a range of 0±2° or within a range of 90±2°, the angle of the slow axis of the outcell retardation layer 30 is within a range of +45°±20, and an angle θ_{A} of the polarization axis of the first polarizer 20 is within a range of 90±2°.

In the present embodiment, although the first substrate 40 is a color filter substrate and the second substrate 60 is a thin-film transistor array substrate, the first substrate 40 may be used as a thin-film transistor array substrate and the second substrate 60 may be used as a color filter substrate.

### Embodiment 4

A liquid crystal display device of Embodiment 4 is a liquid crystal display device in which various members such as color filters and electrodes are disposed on the retardation substrate 10B of Embodiment 2. That is, the liquid crystal display device of Embodiment 4 is a liquid crystal display device in which the retardation substrate 10A of Embodiment 3 is changed to the retardation substrate 10B. Thus, in the present embodiment, features peculiar to this embodiment will be mainly described, and description overlapping with Embodiments 2 and 3 will be omitted as appropriate.

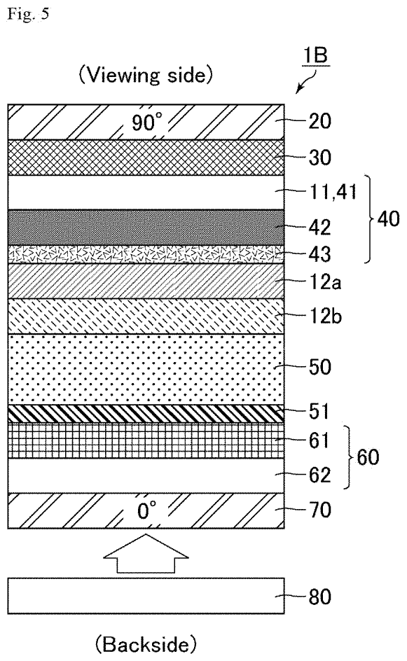

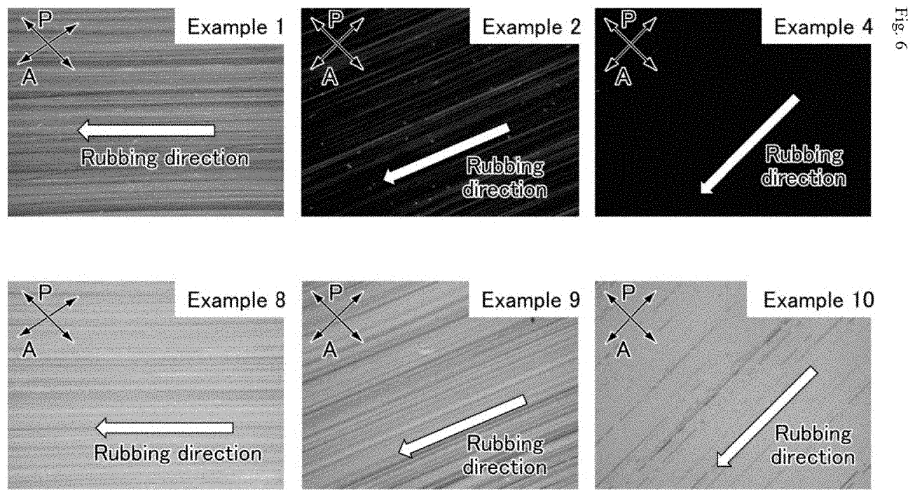

FIG. 5 is a schematic cross-sectional view showing a liquid crystal display device of Embodiment 4. As shown in FIG. 5, a liquid crystal display device 1B has a first polarizer 20, an outcell retardation layer 30, a first substrate 40, a retardation layer 12a, an inorganic film 12b, a liquid crystal layer 50, a second substrate 60, a second polarizer 70, and a backlight 80 in order from the viewing side to the backside. The retardation layer 12a is used as an incell retardation layer.

The first substrate 40 includes a first transparent base material 41, a color filter layer 42, and an overcoat layer 43 in order from the viewing side to the backside. The first transparent base material 41 functions as a base material 11 of the retardation substrate 10B. The second substrate 60 includes a thin-film transistor 61 and a second transparent base material 62 in order from the viewing side to the backside. An alignment film 51 for liquid crystal alignment is provided between the liquid crystal layer 50 and the second substrate 60.

In the liquid crystal display device 1B of Embodiment 4, the liquid crystal layer 50 can be formed directly on the retardation substrate 10B and there is no need to further form an alignment film for liquid crystal alignment on the first substrate 40 side, so that the liquid crystal display device can be produced more easily.

When a surface of the optical functional layer 12 is constituted of the inorganic film 12b, in the liquid crystal display device 1B, it is possible to suppress permeation of impurities into the liquid crystal layer from the retardation layer 12a or the color filter layer 42. As a result, the liquid crystal display device 1B can achieve a high VHR.

The present invention is described below in more detail by way of examples. The examples, however, are not intended to limit the scope of the present invention.

### Production of Liquid Crystal Display Device of Example 1

<Fabrication of First Substrate Provided with Color Filter/Black Matrix Layer>

A color filter/black matrix layer was provided in the FFS mode liquid crystal standard cell to produce a liquid crystal display device of Example 1. Details will be described below.

The color filter/black matrix layer 42 and the overcoat layer 43 were provided on the first transparent base material 41, and supersonic pure water washing was conducted, and thus the first substrate 40 was fabricated.

### <Fabrication of Retardation Layer>

Subsequently, a liquid crystalline polymer having a structure similar to that of the liquid crystalline polymer described in JP 2015-172756 A was dissolved in a mixed solvent of NMP and BCS to prepare a composition for retardation layer in which a solid content concentration of the liquid crystalline polymer was 10 wt %. The composition for retardation layer was applied onto the overcoat layer 43 at 500 rpm by spin coating. Then, after natural drying for approximately 5 seconds, temporary baking was performed at 60° C. for 5 minutes on a hot plate, and linear polarized ultraviolet light 0.1 J having a center wavelength of 365 nm was applied. In addition, main baking was performed at 120° C. for 30 minutes on a hot plate to form a retardation layer before rubbing treatment.

Next, the rubbing treatment was applied to the retardation layer before rubbing treatment using a roller wound with a rayon rubbing cloth such that an angle θ in the rubbing direction was 45°. The rubbing was performed once (the number of repetitions was 1) with a roller pressing amount of 0.4 mm, a roller rotation speed of 500 rpm, and a stage speed (moving speed of the retardation layer before rubbing treatment) of 15 mm/s. Thus, the retardation layer 12a as the optical functional layer 12 was formed on the first substrate 40. The inside of the retardation layer 12a had a retardation of 137.5 nm (λ/4) at a wavelength of 550 nm.

### <Fabrication of Second Substrate Having FFS Mode Thin-Film Transistor>

The thin-film transistor 61, a pixel electrode which was a solid ITO electrode, an insulating film made of SiN, and a common electrode which was a comb-shaped ITO electrode were provided on the second transparent base material 62, and supersonic pure water washing was conducted, and thus the second substrate 60 was fabricated.

### <Fabrication of Alignment Film for Liquid Crystal Alignment>

Subsequently, an alignment film material containing polyimide was applied onto the second substrate 60, and the rubbing treatment was performed to form the alignment film 51 for liquid crystal alignment.

### <Production of Liquid Crystal Display Device>

The first substrate 40 on which the retardation layer 12a was formed and the second substrate 60 on which the alignment film 51 for liquid crystal alignment was formed were bonded such that the retardation layer 12a and the alignment film 51 for liquid crystal alignment faced each other, to form an empty cell. Subsequently, positive liquid crystal molecules were injected into the empty cell.

In addition, the outcell retardation layer 30 was adhered to a surface of the first base material 41 in the first substrate 40, the surface being opposite to the color filter layer 42, using an adhesive layer (not shown). Here, for the outcell retardation layer 30, a λ/4 plate having a retardation of 137.5 nm at a wavelength of 550 nm was used. The angle of the slow axis of the outcell retardation layer was 45.

Next, the first polarizer 20 was disposed on the outcell retardation layer 30, and the second polarizer 70 was disposed on the second transparent base material. Furthermore, a white light source as the backlight 80 was disposed on the second polarizer 70 side, and a liquid crystal display device 1A of Example 1 was produced. When the first polarizer 20 and the second polarizer 70 were bonded to each other, they were disposed such that the angle θ₂ of the slow axis inside the retardation layer 12a was −45°, and the first polarizer 20 was then rotated with respect to the second polarizer 70, and the first polarizer 20 was disposed to minimize black luminance. The liquid crystal display device 1A of Example 1 had the retardation layer 12a (incell retardation layer) having a retardation of λ/4 and the outcell retardation layer 30 having a retardation of λ/4. The angle of the slow axis inside the retardation layer 12a was −45°, and the angle of the slow axis of the outcell retardation layer 30 was 45°. That is, the liquid crystal display device 1A of Example 1 had a configuration of a low reflection liquid crystal display device capable of improving outdoor visibility.

### Production of Liquid Crystal Display Devices of Examples 2 to 7

Liquid crystal display devices 1A of Examples 2 to 7 were produced in the same manner as in Example 1 except that the angle 9 in the rubbing direction was changed to the angles shown in Table 1 below.

### Production of Liquid Crystal Display Device of Example 8

A liquid crystal display device 1A of Example 8 was produced in the same manner as in Example 1 except that the roller pressing amount in the rubbing treatment was changed to 0.2 mm.

### Production of Liquid Crystal Display Devices of Examples 9 and 10

Liquid crystal display devices 1A of Examples 9 and 10 were produced in the same manner as in Example 8 except that the angle θ in the rubbing direction was changed to the angles shown in Table 1 below.

In Examples 1 to 10, the angle θ_{A} of the polarization axis of the first polarizer 20, the angle θ₁ of the slow axis of the surface of the optical functional layer 12, the angle θ₂ of the slow axis inside the retardation layer 12a, and an absolute value |θ₁−θ₂| of a difference between the angle θ₁ and the angle θ₂ are shown in Table 1 below.

TABLE 1

| | | Angle | | Angle | Angle θ₁ [°] | Angle θ₂ [°] | | | |
|---|---|---|---|---|---|---|---|---|---|
| | Roller | θₚ [°] of | | θ_{A} [°] of | of slow axis | of slow axis | | | |
| | pressing | polarization | Angle θ [°] | polarization | of surface of | inside | | | Black |
| | amount | axis of | in rubbing | axis of | optical func- | retardation | \|θ₁ − θ₂\| | Dark | luminance |
| Example | [mm] | polarizer | direction | analyzer | tional layer | layer | [°] | room CR | [cd/m²] |
| Example 1 | 0.4 | 0 | 45 | 77.5 | −12.5 | −45 | 32.5 | 18 | 0.56 |
| Example 2 | | 0 | 67.5 | 88 | −2.0 | −45 | 43 | 114 | 0.088 |
| Example 3 | | 0 | 77 | 88.4 | −1.6 | −45 | 43.4 | 323 | 0.031 |
| Example 4 | | 0 | 90 | 91.5 | 1.5 | −45 | 46.5 | 476 | 0.021 |
| Example 5 | | 0 | 103 | 91.7 | 1.7 | −45 | 46.7 | 357 | 0.028 |
| Example 6 | | 0 | 112.5 | 94 | 4.0 | −45 | 49 | 147 | 0.068 |
| Example 7 | | 0 | 135 | 102.5 | 12.5 | −45 | 57.5 | 25 | 0.4 |
| Example 8 | 0.2 | 0 | 45 | 67.8 | −22.2 | −45 | 22.8 | 10 | 1 |
| Example 9 | | 0 | 67.5 | 81.5 | −9.4 | −45 | 35.6 | 14 | 0.71 |
| Example 10 | | 0 | 90 | 85.5 | −4.5 | −45 | 40.5 | 13 | 0.77 |
| (Reference) | | | | | | | | Approx- | Approx- |
| General FFS mode liquid | | | | | | | | imately | imately |
| crystal display device | | | | | | | | 1000 | 0.010 |
| (Reference) | | | | | | | | Approx- | Approx- |
| Low reflection liquid | | | | | | | | imately | imately |
| crystal display device of | | | | | | | | 300 to 400 | 0.033 to |
| Comparative Embodiment 1 | | | | | | | | | 0.025 |

### Evaluation of Liquid Crystal Display Devices of Examples 1 to 10

As described above, in Examples 1 to 10, the retardation layer 12a was subjected to the rubbing treatment, and the angle θ₁ of the slow axis of the surface of the optical functional layer 12 was made different from the angle θ₂ of the slow axis inside the retardation layer 12a, whereby the liquid crystal display device 1A could be produced without forming an alignment film for liquid crystal alignment on the optical functional layer 12.

Although the angles θ in the rubbing direction in Examples 1 and 8 were the same as each other, the slow axis θ₁ of the surface of the optical functional layer 12 could be changed by changing the roller pressing amount in the rubbing treatment. Similarly to Examples 2 and 9 and Examples 4 and 10, the slow axis θ₁ of the surface of the optical functional layer 12 could be changed by changing the roller pressing amount in the rubbing treatment.

### (Evaluation of Dark Room Contrast and Black Luminance)

For the liquid crystal display devices 1A of Examples 1 to 10, the dark room contrast (hereinafter, also referred to as dark room CR) and black luminance were measured by the following methods. The results are shown in Table 1 above. The dark room contrast is defined as dark room CR=(white luminance/black luminance). As the white luminance, front luminance from the liquid crystal display device 1A was measured using a luminance meter (SR-UL1 manufactured by Topcon Corporation) by setting a drive voltage of the liquid crystal display device 1A disposed on backlight in the on state to approximately 5V (voltage at which the transmittance was maximized with V-T characteristics (transmittance characteristics of light to the drive voltage)). On the other hand, as the black luminance, front luminance from the liquid crystal display device 1A was measured using the luminance meter (SR-UL1) by setting a drive voltage of the liquid crystal display device 1A disposed on backlight in the on state to 0 V. When each luminance was measured, the measurement was carried out in a dark room. Table 1 describes reference data for the dark room contrast and black luminance of a general (not low reflection) FFS mode liquid crystal display device and a low reflection liquid crystal display device of Comparative Embodiment 1.

As seen from Table 1, in the liquid crystal display devices 1A of Examples 1 to 10, which were low reflection liquid crystal display devices, and the low reflection liquid crystal display device of Comparative Embodiment 1, the dark room CR was lower than that of the general FFS mode liquid crystal display device. The low reflection liquid crystal display device has an incell retardation layer and an outcell retardation layer in addition to the configuration of the general FFS mode liquid crystal display device. Although the incell retardation layer and the outcell retardation layer are disposed so as to cancel the retardation each other, when the retardation cannot be completely canceled, light leakage may occur at the time of black display to increase the black luminance, and the dark room CR may decrease. For these reasons, it is considered that the dark room CR of the low reflection liquid crystal display device has become lower than the dark room CR of the general FFS mode liquid crystal display device.

However, while the internal reflectance of the general FFS mode liquid crystal display device is about 1.5%, the internal reflectance of the low reflection liquid crystal display device can be suppressed to about 0.3%, and the low reflection liquid crystal display device can be improved in outdoor visibility as compared with the general FFS mode liquid crystal display device.

Furthermore, as seen from Table 1, the dark room CR of the liquid crystal display device 1A of Example 4 was in a range of 400 to 499, and the dark room CR of the liquid crystal display devices 1A of Examples 3 and 5 was in a range of 300 to 399. The liquid crystal display devices 1A of Examples 3 to 5 all had a dark room CR comparable to that of the low reflection liquid crystal display device of Comparative Embodiment 1. From the above results, it was found that it was preferable for the angle θ₁ of the slow axis of the surface of the optical functional layer 12 and the angle θ₂ of the slow axis inside the retardation layer 12a to satisfy the following (Equation 1), and it was more preferable for the angles θ₁ and θ₂ to satisfy the following (Equation 2).

43°<|θ₁−θ₂|≤47° (Formula 1)

44≤|θ₁−θ₂|≤46.5° (Formula 2)

FIG. 6 shows photomicrographs at the time of black display of the liquid crystal display devices of Examples 1, 2, 4 and 8 to 10. FIG. 6 shows a polarization axis A of the first polarizer 20, a polarization axis P of the second polarizer 70, and the rubbing direction in the rubbing treatment. As shown in FIG. 6, the liquid crystal display device 1A of Example 4 was sufficiently dark and excellent in black luminance at the time of black display, as compared with the liquid crystal display devices 1A of Examples 1, 2 and 8 to 10.

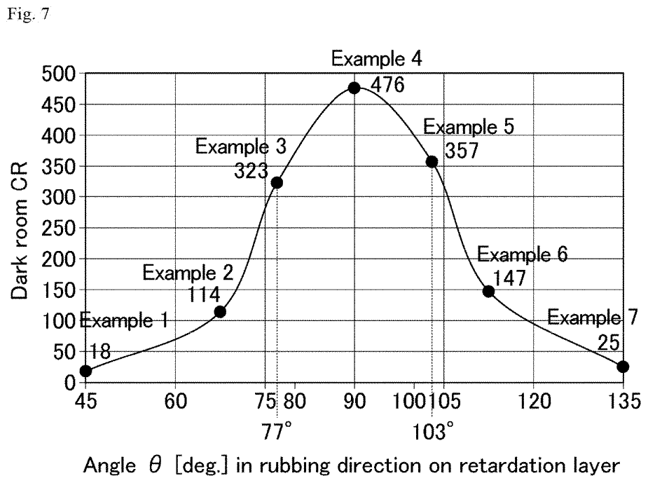

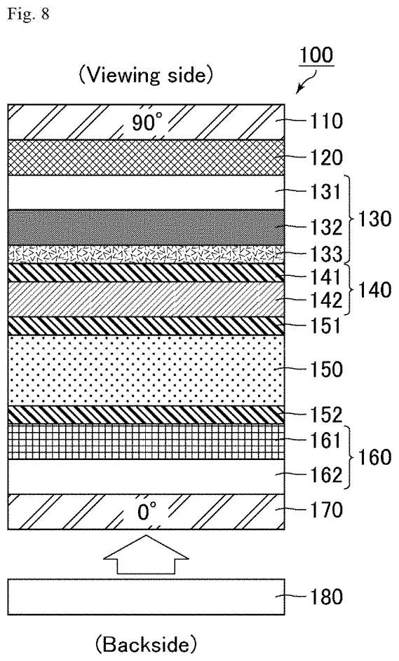

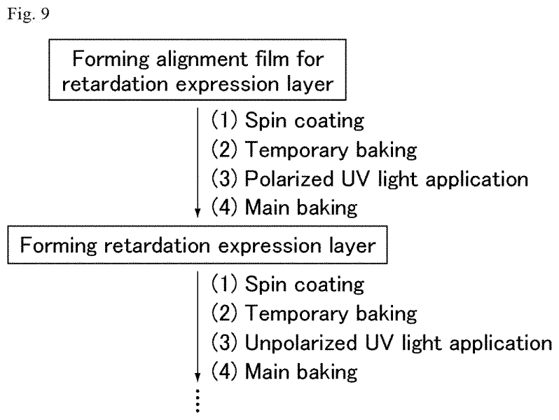

FIG. 7 is a graph in which a relationship of the dark room contrast to the angle in the rubbing direction in Examples 1 to 7 is plotted. When the roller pressing amount in the rubbing treatment is 0.4 mm, it is considered that if the angle θ in the rubbing direction is set to 77°≤θ103° as shown in FIG. 7, it is possible to obtain the dark room contrast (300 or more) comparable to that of the low reflection liquid crystal display device of Comparative Embodiment 1.

### [Additional Remarks]

One aspect of the present invention may be the retardation substrates 10A and 10B including the base material 11 and the optical functional layer 12 provided on one surface of the base material 11, in which the optical functional layer 12 may include the retardation layer 12a, and a direction of a slow axis of a surface of the optical functional layer 12 may be different from a direction of a slow axis inside the retardation layer 12a.

In the retardation substrates 10A and 10B, since the direction of the slow axis of the surface of the optical functional layer 12 is different from the direction of the slow axis inside the retardation layer 12a, a desired retardation is imparted using the retardation substrate 10A, and, at the same time, liquid crystal molecules of the liquid crystal layer 50 can be aligned at a desired angle using the slow axis of the surface of the optical functional layer 12 without forming an alignment film for liquid crystal alignment on the optical functional layer 12. As a result, the liquid crystal display devices 1A and 1B can be produced more easily.

An angle formed by the direction of a slow axis of a surface of the optical functional layer 12 and the direction of a slow axis inside the retardation layer 12a may be more than 43° and 47° or less.

This makes it possible to improve the dark room contrast of the liquid crystal display devices 1A and 1B.

The surface of the optical functional layer 12 may include the retardation layer 12a.

This makes it possible to reduce the number of members constituting the liquid crystal display device 1A, and to produce the liquid crystal display device more easily.

The optical functional layer 12 may further include the inorganic film 12b, and the surface of the optical functional layer 12 may include the inorganic film 12b.

This makes it possible to increase the VHR of the liquid crystal display device 1B.

The optical functional layer 12 may have a retardation of λ/4.

This makes it possible to effectively suppress external light reflection in the liquid crystal display devices 1A and 1B including the retardation layer 12a as an incell retardation layer.

Another aspect of the present invention may be the liquid crystal display devices 1A and 1B including the retardation substrates 10A and 10B.

The liquid crystal display devices 1A and 1B may further include the substrate 60 facing the retardation substrates 10A and 10B, and the liquid crystal layer 50 provided between the retardation substrates 10A and 10B and the substrate 60 facing the retardation substrates 10A and 10B. The retardation substrates 10A and 10B may be disposed such that the optical functional layer 12 is in contact with the liquid crystal layer 50.

This makes it possible to produce the liquid crystal display devices 1A and 1B having an incell retardation layer more easily.

### REFERENCE SIGNS LIST

1A, 1B: liquid crystal display device
10A, 10B: retardation substrate
11: base material
12: optical functional layer
12a: retardation layer
12b: inorganic film
20: first polarizer (analyzer)
30, 120: outcell retardation layer
40, 130: first substrate
41, 131: first transparent base material
42, 132: color filter/black matrix layer
43, 133: overcoat layer
50, 150: liquid crystal layer
51: alignment film for liquid crystal alignment
60: second substrate (facing substrate)
61, 161: thin-film transistor layer
62, 162: second transparent base material
70: second polarizer (polarizer)
80, 180: backlight
100: low reflection liquid crystal display device of Comparative Embodiment 1
110: first polarizer
140: incell retardation layer
141: alignment film for retardation expression layer
142: retardation expression layer
151: first alignment film for liquid crystal alignment
152: second alignment film for liquid crystal alignment
160: second substrate
170: second polarizer
A: analyzer polarization axis
P: polarization axis of polarizer
θ: angle in rubbing direction
θ₁: angle of slow axis of surface of optical functional layer
θ₂: angle of slow axis inside retardation layer
θ_{A}: angle of polarization axis of analyzer
θ_{P}: angle of polarization axis of polarizer

1. A retardation substrate comprising:
a base material; and
an optical functional layer provided on one surface of the base material,
the optical functional layer including a retardation layer, and
a direction of a slow axis of a surface of the optical functional layer being different from a direction of a slow axis inside the retardation layer.

2. The retardation substrate according to claim 1,
wherein an angle formed by the direction of the slow axis of the surface of the optical functional layer and the direction of the slow axis inside the retardation layer is more than 43° and 47° or less.

3. The retardation substrate according to claim 1,
wherein the surface of the optical functional layer includes the retardation layer.

4. The retardation substrate according to claim 1,
wherein the optical functional layer further includes an inorganic film, and
the surface of the optical functional layer includes the inorganic film.

5. The retardation substrate according to claim 1,
wherein the optical functional layer has a retardation of λ/4.

6. A liquid crystal display device comprising the retardation substrate according to claim 1.

7. The liquid crystal display device according to claim 6, further comprising:
a substrate facing the retardation substrate; and
a liquid crystal layer provided between the retardation substrate and the substrate facing the retardation substrate,
the retardation substrate being disposed such that the optical functional layer is in contact with the liquid crystal layer.
